(19) United States
(12) Patent Application Publication
(10) Pub. No.: US 2013/0306170 A1
(43) Pub. Date: Nov. 21, 2013

(54) WATER CONTROL AND SECURITY SYSTEM

(71) Applicant: FEDERICO RIVERA, MANATI, PR (US)

(72) Inventor: FEDERICO RIVERA, MANATI, PR (US)

(21) Appl. No.: 13/950,999

(22) Filed: Jul. 25, 2013

Related U.S. Application Data
(63) Continuation of application No. 13/109,224, filed on May 17, 2011.

(51) Int. Cl. F16L 55/00

(52) U.S. Cl. CPC F16L 55/00
USPC 137/551

(57) ABSTRACT

A water control and security system includes one or more leak detection units for detecting the presence of water in undesirable locations, a water-source control unit includes a controller that is in communication with a valve functioning to allow and prevent water from entering a structure, and a remote control unit capable of communicating with each of the water source control unit and the one or more leak detection units.

### CROSS-REFERENCE TO RELATED APPLICATIONS

This application is a continuation of, and claims the benefit to copending U.S. application Ser. No. 13/109,224 filed on 17 May, 2011, the contents of which are incorporated herein by reference.

### BACKGROUND

### Field of the Invention

The present invention relates generally to water control systems, and more particularly to a system for remotely enabling and disabling the supply of water to a building or structure.

Each year, buildings and residences across the globe suffer damage caused from water. In many cases, the water damage is the result of a broken pipe, a leaky appliance, or the result of carelessness wherein a faucet, shower or tub is left running and eventually overflows. As such, water damage can include physical damage to components such as drywall, carpeting, electrical wiring, furniture, electronics and personal belongings, for example, and can also pose serious liability to building owners in the form of slip and fall accidents, mold remediation and other health issues. For this reason, the financial toll of water damage is directly proportional to the amount of time it takes to perform corrective action and stop the flow of water

There are several known systems for controlling water flow into a building, including: U.S. Pat. No. 6,691,724, U.S. Pat. No. 6,522,979, U.S. Pat. No. 6,491,062, U.S. Pat. No. 6,526,807, and U.S. Pat. No. 7,306,008. The present invention, directed to a water control and security system differs from the foregoing documents. The manner by which will become more apparent in the description which follows, particularly when read in conjunction with the accompanying drawings.

### SUMMARY OF THE INVENTION

The present invention is directed to a water control and security system for controlling the supply of water to a building. One embodiment of the present invention can include one or more leak detection units functioning to detect the presence of water in undesirable locations, and to transmit a wireless alarm upon detection. The system can also include a water-source control unit having a controller that is in communication with a valve that can be interposed between the water supply source and the building plumbing. The system can also include a remote control unit capable of communicating with each of the water source control unit and the one or more leak detection units.

Another embodiment of the present invention can include the ability of the system to immediately disable all water entering the building upon the occurrence of a leak situation.

Yet another embodiment of the present invention can include the ability to control the operation of the valve in response to a user input onto either of the controller and the remote control unit.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a simplified schematic drawing of a water control and security system that is useful for understanding the inventive concepts disclosed herein.

FIG. 2A is a front view of the water-source control unit of the system, in accordance with one embodiment of the invention.

FIG. 2B is a schematic block diagram of the water-source control unit of the system, in accordance with one embodiment of the invention.

FIG. 3 is a perspective view of the water-source control unit in operation, according to one embodiment of the invention.

FIG. 4 is a perspective view of a leak detection unit in accordance with one embodiment of the invention.

FIG. 5A is a front view of the remote control unit of the system, in accordance with one embodiment of the invention.

FIG. 5B is a schematic block diagram of the remote control unit of the system, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

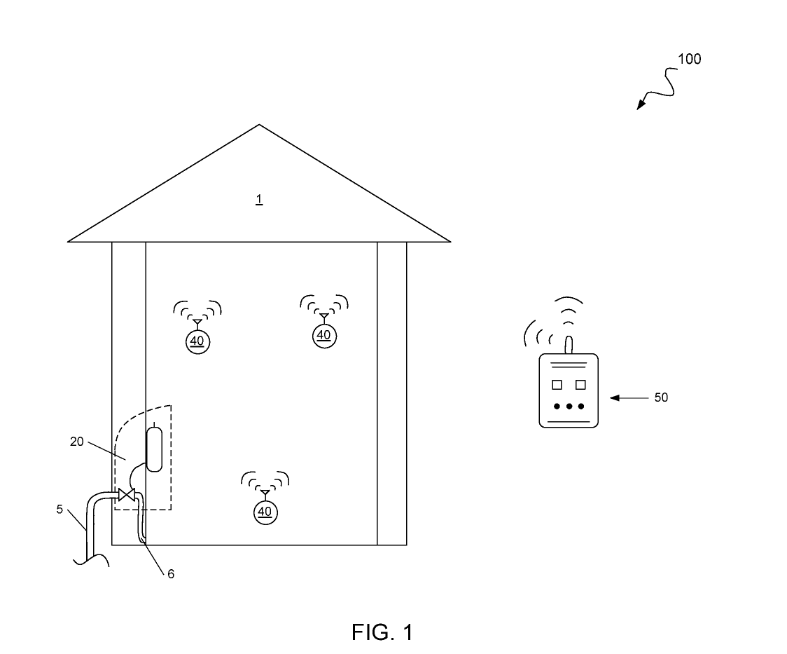

FIG. 1 illustrates one embodiment of a water control and security system 100 utilized in a building 1 that is useful for understanding the inventive concepts disclosed herein. As shown, the system 100 can include a water-source control unit 20 that is in communication with a plurality of leak detection units 40, and a remote operation device 50.

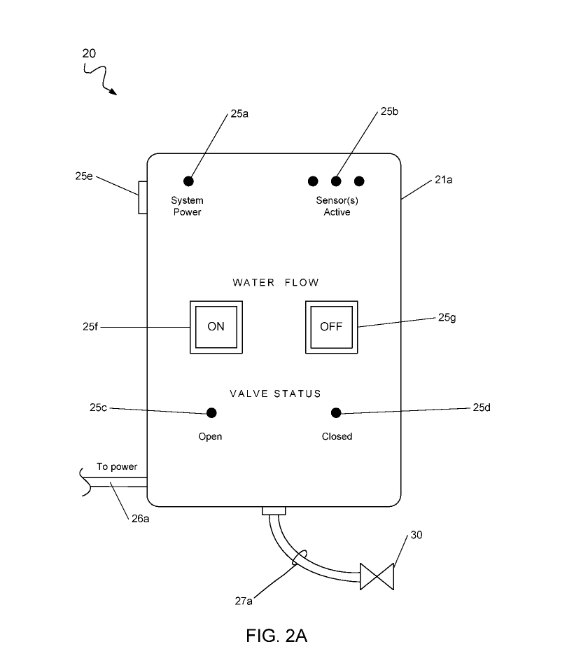

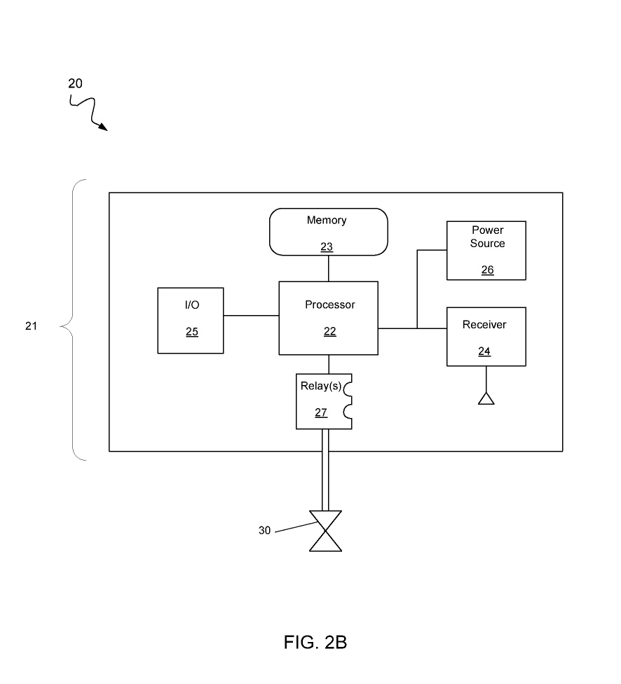

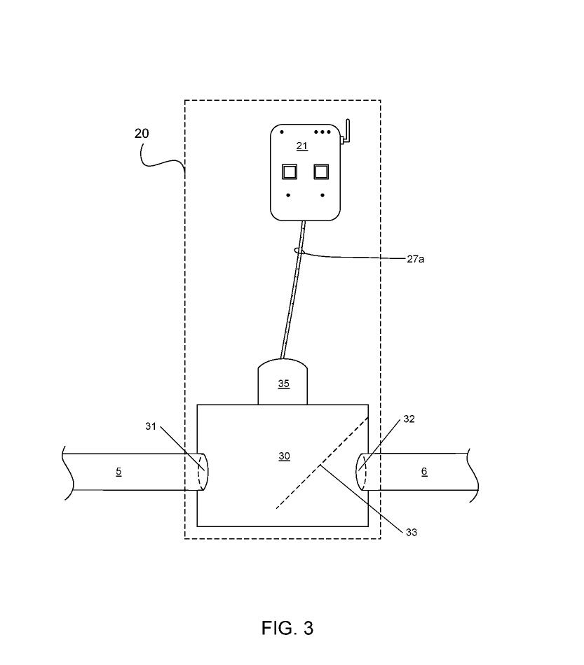

FIGS. 2A, 2B and 3 illustrate one embodiment of a water-source control unit 20 that includes a controller 21 and a valve 30. The controller 21 can function to communicate with each of the leak detection units 40 and the remote operation device 50 in order to provide operating instructions to the valve 30.

In one preferred embodiment, the controller 21 can include a resilient waterproof main body 21a for housing a processor 22 that is conventionally connected to an internal memory 23, a wireless receiver 24, one or more input/output units 25, a power source 26 and one or more electrical relays 27.

The housing 21a can preferably be constructed from injection molded plastic having a plurality of connectors (not shown) for securely positioning each of the elements 22-27 in a secure and waterproof manner. To this end, the housing 21a can take any number of distinct shapes and can be constructed from any number of known materials.

The processor 22 can act to execute program code stored in the memory 23 in order to allow the device to perform the functionality described herein. Processors are extremely well known in the art, therefore no further description will be provided.

Memory 23 can act to store operating instructions in the form of program code for the processor 22 to execute. As such, memory 23 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device. Additionally memory 23 can also include one or more cache memories that provide temporary storage of at least some program code in order to reduce the number of times program code must be retrieved from a bulk storage device during execution. Each of these devices is well known in the art.

The receiver 24 can function to communicate with each of the leak detection units 40 and the remote activation unit 50. In one preferred embodiment, the receiver can include a variable radio wave receiver having a unique radio frequency chip capable of receiving and translating a plurality of independent radio frequencies, which can then be sent to the processor 22 and/or the memory 23. Although described as using radio transmission and reception frequencies, other communication mediums and their associated components are also contemplated. Several suitable examples including infrared (IR), Bluetooth, RFID, microwave, Ethernet, Wi-Fi and other conventional mediums.

A plurality of input/output units 25 can be provided in order to communicate with a user. As described herein, the input/output units can include any number of visual, audio and/or feedback devices such as lights, speakers and buttons, for example. As shown best in FIG. 2A, one embodiment of the controller can include visual indicators comprising one or more light emitting diodes (LED's), to indicate the system power 25a, leak sensor(s) active 25b, valve-status-open 25c and valve-status-closed 25d, for example. Additionally, a plurality of push buttons can be provided for accepting user inputs such as power on/off 25e, water-flow-on 25f (valve open) and/or water-flow-off 25g (valve closed), for example. Further, one or more communication ports 25h, such as a USB port, for example can be provided in order to allow the controller to interface with a secondary device such as a building alarm system, for example, in order to utilize the alarm system user contact protocols for alerting the building owner that a leak situation has occurred.

Although described above as including specific components and functionality, this is for illustrative purposes only, as any number of different input/output devices, providing any number of different functionality can be included without deviating from the inventive concepts disclosed herein.

The power module 26 can preferably be connected to the building's A/C electrical system via a standard electrical cable 26a in order to provide power to each component of the water-source control unit 20 in a conventional manner. However, an optional battery backup system (not illustrated) can be provided to ensure proper operation of the system in the event that no building power is available.

One or more electrical relays 27 can be provided to supply the received electrical power to the valve 30. As shown, the relay can be in communication with the valve via a conventional cable 27a.

As shown best in FIG. 3, the valve 30 can include an input channel 31 that is in communication with the main water supply line 5, an output channel 32 that is in communication with the building plumbing 6, and an inner chamber/gate 33 capable of allowing or restricting the flow of water between the input and output channels, thereby transitioning the valve between an open and closed state, respectively. The valve further including a valve actuator 35 which can function to physically manipulate the chamber 33 between an open and closed position. As such, the valve actuator can include a conventional electric motor and/or solenoid mechanism, for example. Although illustrated as separate components, this is for illustrative purposes only, as a single, integrated solenoid valve device can also be utilized. As these items and their associated functionality are extremely well known in the art, no further description will be provided herein.

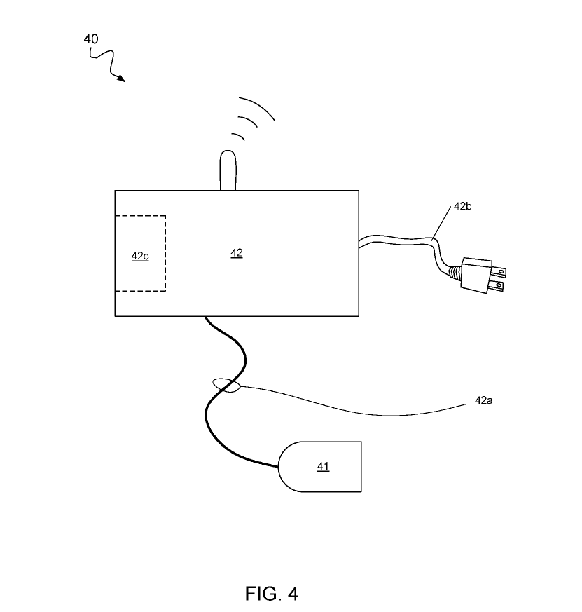

FIG. 4 illustrates one embodiment of a leak detection unit 40 that includes a water/moisture sensor 41 that is in communication with a transmitter 42.

As described herein, the water sensor 41 can include any device capable of detecting the presence of water and activating an alarm signal. The transmitter 42 can be in direct communication with the sensor 41 via a cable 42a, and can include any device capable of transmitting the alarm signal to the receiver 24 of the control unit, and/or the receiver 54 of the remote unit described below. In one preferred embodiment, the transmitter can include a variable radio wave transmitter having a unique radio frequency chip capable of transmitting a plurality of independent radio frequencies. As shown, the unit 40 can include a power plug 42a and an optional battery system 42c for providing the necessary power requirements to the devices 41 and 42.

As described herein, the alarm signal can include a wireless transmission emanating from the transmitter 42 to one or both of the receivers 24 and 54 indicating that a leak situation is occurring. To this end, each of the plurality of leak detection sensors 40 can transmit an identical signal, or can transmit a unique signal capable of being interpreted by the controller and/or remote controller so as to identify which of the plurality of leak detection units transmitted the signal.

Although illustrated as separate components, this is for illustrative purposes only, as those of skill in the art will recognize that the sensor 41 and transmitter 42 described above can also be incorporated into a single device. One suitable example, including the commercially available Zircon® 63921 wireless leak sensor, for example. Moreover, any number of other communication mediums and their associated components are also contemplated. Several suitable examples including infrared (IR), Bluetooth, RFID, microwave, Ethernet, Wi-Fi and other conventional mediums, for example. Finally, although described above as including wireless transmission and reception, other embodiments are contemplated wherein the devices 40 and 20 can be connected via traditional communication wires.

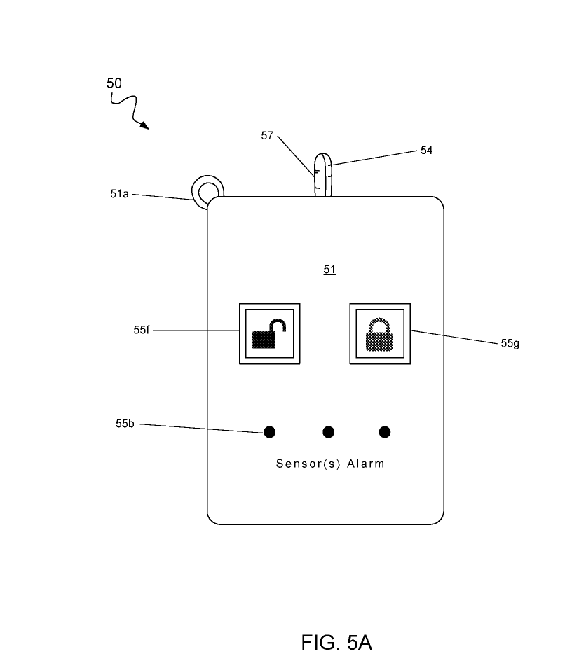

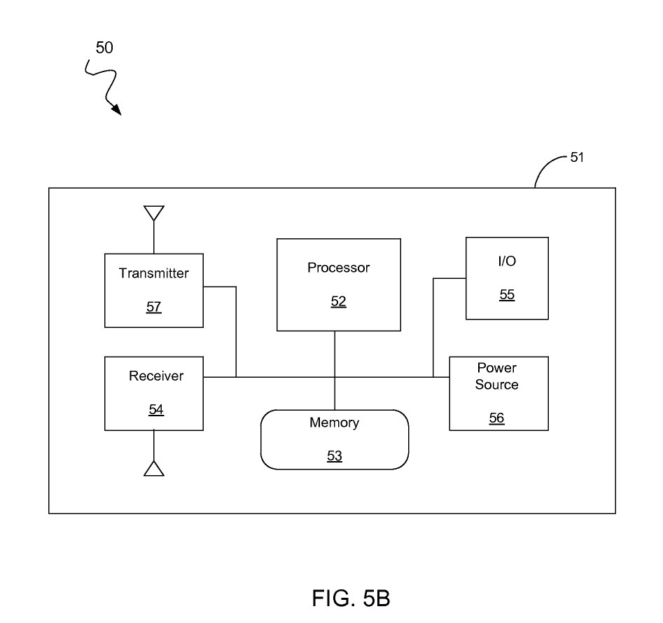

As shown in FIGS. 5A and 5B, the system 100 can further include a remote operation device 50 that is capable of providing two-way communication with the plurality of leak detection units 40 and the control unit 20.

In the preferred embodiment, the device 50 can include a resilient small waterproof main body 51 having a small lightweight shape and construction suitable for housing a processor 52 that is conventionally connected to an internal memory 53, a wireless receiver 54, one or more input/output units 55, a power source 56 and a transmitter 57.

As shown, the device can include any number of retention devices such as a keychain ring 51a suitable for attaching the device 50 to a user on the go. Moreover, as described herein, each of the processor 52, memory 53, receiver 54 and transmitter 57 can be substantially the same as the processor 22, memory 23, receiver 24 and transmitter 42 described above. The power source 56 can preferably include lightweight batteries such as lithium-ion, for example, suitable for providing power to the device components.

As shown, the main body 51 can preferably include one or more one or more light emitting diodes (LED's) 55b, each tied to a particular leak detection sensor 40, and configured to illuminate when a signal is receive form a particular sensor indicating a leak situation. Of course, other embodiments wherein a single light is provided and configured to illuminate when a signal is received from any of the sensors can also be provided. Additionally, a plurality of push buttons can be provided for accepting user inputs such as water-flow-on 55f (valve open) and/or water-flow-off 55g (valve closed), for example.

In operation, a plurality of leak detection units 40 can be placed throughout a building/home 1 at locations susceptible to water leaks such as the basement, underneath appliances, or at water pipe junctions, for example. Upon detecting the presence of water, the leak detection unit(s) can transmit a signal to the each of the control unit 20 and the remote operation device 50 indicating that a leak situation has occurred.

Upon receiving an alarm signal from (i.e., wireless communication) from one or more of the leak detection units, the control unit 20 can function to immediately transition the valve 30 from an open position to a closed position, thereby preventing additional water from entering the building. Upon closing the valve, the status light on the controller can transition from the open indication 25c to the closed indication 25d. Finally, if equipped, the controller can also illuminate the appropriate sensor light 25b indicating which of the plurality of leak detection sensors sent the alarm, in order to allow the user to more quickly locate and identify the source of the leak.

With respect to the remote control unit 50, upon receiving the alarm signal from one or more of the sensors 40, the unit can immediately illuminate the one or more sensor lights 55b to notify the user that a leak situation has occurred. Additionally, when no leak situation is present, the remote unit can function to transmit instructions to the controller via the transmitter 57 and receiver 24. Such instructions can include a valve open instruction corresponding to a user input onto the button 55f, and a valve close instruction corresponding to a user input onto button 55g. Such a feature can provide the user with the ability to remotely operate the flow of water into a building remotely and is particularly beneficial at times when the user is leaving the building and wants to ensure the water flow is either on or off.

As described herein, each of the control unit 20 and the remote control unit 50 can include any appropriate operating system, programming and/or circuit logic suitable for achieving the functionality described herein. To this end, although described with respect to specific circuits, this is for illustrative purposes only, as any number of other circuits (analogue or digital) can be substituted or provided in a manner sufficient to achieve the inventive concepts described above.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A water control and security system, comprising:
one or more leak detection units, each of said units including
a sensor that is configured to detect the presence of water and generate an alarm, and
a transmitter that is in communication with the sensor, said transmitter being configured to transmit a wireless signal containing the alarm;
a water-source control unit that includes
a valve having an input, an output and a valve actuator, said valve being configured to be interposed between a water supply source and a building plumbing,
a controller having a plurality of visual indicators, a plurality of user inputs, and a wireless receiver, said controller being configured control an operation of the valve based on at least one of a user input and a received wireless signal; and
a remote control unit having at least one visual indicator, a plurality of user inputs, a transmitter and a receiver, said remote control unit being configured to communicate with each of the one or more leak detection units and the water-source control unit.

2. The system of claim 1, wherein the plurality of visual indicators on the controller include a system power indicator, an active sensor indicator, a valve status open indicator, and a valve status closed indicator.

3. The system of claim 1, wherein the plurality of user inputs on the controller include a power on/off button, a water-flow-on button, and a water-flow-off button.

4. The system of claim 3, wherein the controller is configured to instruct the valve to open upon engagement of the water-flow-on button, and to instruct the valve to close in response to engagement of the water-flow-off button or a received wireless alarm.

5. The system of claim 1, wherein at least one visual indicator on the remote control unit includes a sensor alarm indicator that is configured to illuminate upon receiving a wireless alarm signal from at least one of the leak detection units.

6. The system of claim 1, wherein the plurality of user inputs on the remote control unit includes a water-flow-on button and a water-flow-off button.

7. The system of claim 6, wherein the remote control unit is configured to transmit a valve-open instruction to the controller in response to an engagement of the water-flow-on button, and
to transmit a valve-closed instruction to the controller in response to an engagement of the water-flow-off button.

8. The system of claim 7, wherein the controller is configured to instruct the valve to open upon receipt of the valve-open instruction, and to instruct the valve to close upon receipt of at least one of the valve-closed instruction and an alarm signal.

9. The system of claim 1, wherein each of the control unit, the remote control unit and the at least one leak detection unit are configured to communicate via at least one of a radio wave, infrared, Bluetooth, RFID, microwave, Ethernet, and Wi-Fi.

10. The system of claim 1, wherein each of the at least one leak detection units are configured to generate and transmit an identical alarm signal.

11. The system of claim 1, wherein the plurality of visual indicators on the controller further includes a plurality of lighted elements each tied to a particular leak detection unit, and configured to illuminate upon receipt of a unique signal from the particular leak detection unit that includes an alarm.

12. The system of claim 1, wherein the plurality of visual indicators on the remote control unit further includes a plurality of lighted elements each tied to a particular leak detection unit, and configured to illuminate upon receipt of a unique signal from the particular leak detection unit that includes an alarm.

13. The system of claim 1, wherein at least one of the one or more leak detection units and the control unit includes a battery backup power supply configured to operate the system in the event of a building power outage.
